(19) United States
(12) Patent Application Publication
(10) Pub. No.: US 2021/0304286 A1
(43) Pub. Date: Sep. 30, 2021

(54) COMPUTER READABLE RECORDING MEDIUM, WALLET SYSTEM, AND METHOD OF PROPOSING PRODUCT

(71) Applicant: TOYOTA JIDOSHA KABUSHIKI KAISHA, Toyota-shi (JP)

(72) Inventors: Hiroto TOMIDA, Tokyo-to (JP); Tae SUGIMURA, Miyoshi-shi (JP); Ryuta YANAGISAWA, Ichikawa-shi (JP); Takuya TORIU, Tokyo-to (JP); Daisuke KOMIYAMA, Tokyo-to (JP); Zejun MEI, Fujimi-shi (JP); Kazuhiko YAMAGUCHI, Nagoya-shi (JP); Honami MORI, Nagoya-shi (JP)

(73) Assignee: TOYOTA JIDOSHA KABUSHIKI KAISHA, Toyota-shi (JP)

(21) Appl. No.: 17/198,531

(22) Filed: Mar. 11, 2021

(30) Foreign Application Priority Data
Mar. 30, 2020 (JP) 2020-060519

(51) Int. Cl. G06Q 30/06; G06Q 30/02; G06Q 20/36; G06Q 20/32; G01C 21/20

(52) U.S. Cl. CPC G06Q 30/0631; G06Q 30/0639; G06Q 30/0283; G06F 3/14; G06Q 20/327; G01C 21/206; G06Q 20/36

(57) ABSTRACT

A wallet program causes a processor of a computer to execute: acquiring, when it is detected that a first user has arrived in a vicinity of a predetermined store, a purchase history of products of a second user in the store from a first server; and displaying, based on the purchase history, a product to be purchased by the first user in the store on a display provided in a mobile terminal.

The present application claims priority to and incorporates by reference the entire contents of Japanese Patent Application No. 2020-060519 filed in Japan on Mar. 30, 2020.

### BACKGROUND

The present disclosure relates to a computer readable recording medium, a wallet system, and a method of proposing a product.

JP 6508695 B2 discloses a wallet system that may add information to be advertised to a user to a past use history of electronic money by a terminal of the user.

### SUMMARY

There is a need for a computer readable recording medium, a wallet system, and a method of proposing a product that improve convenience of a wallet system by utilizing not only a use history of electronic money by a terminal of a user but also a use history of electronic money of a third party.

According to one aspect of the present disclosure, there is provided a non-transitory computer-readable recording medium on which an executable program is recorded, the program causing a processor of a computer to execute: acquiring, when it is detected that a first user has arrived in a vicinity of a predetermined store, a purchase history of products of a second user in the store from a first server; and displaying, based on the purchase history, a product to be purchased by the first user in the store on a display provided in a mobile terminal.

### BRIEF DESCRIPTION OF THE DRAWINGS

FIG. 1 is a diagram schematically illustrating a configuration of a wallet system according to an embodiment;

FIG. 2 is a block diagram illustrating details of each component of the wallet system according to the embodiment;

FIG. 3 is a diagram illustrating an example of information to be displayed on a first terminal in the wallet system according to the embodiment;

FIG. 4 is a diagram illustrating an example of information to be displayed on the first terminal in the wallet system according to the embodiment; and

FIG. 5 is a flowchart illustrating an example of a method of proposing a product executed by the wallet system according to the embodiment.

### DETAILED DESCRIPTION

A computer readable recording medium storing a wallet program, a wallet system, and a method of proposing a product according to an embodiment of the present disclosure will be described with reference to the drawings. Note that components in the following embodiment include those which may be easily replaced by a person skilled in the art, or those which are substantially the same.

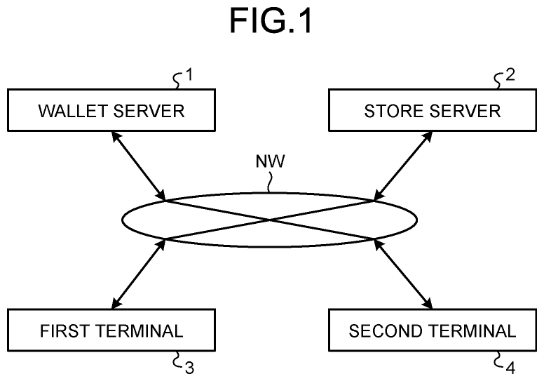

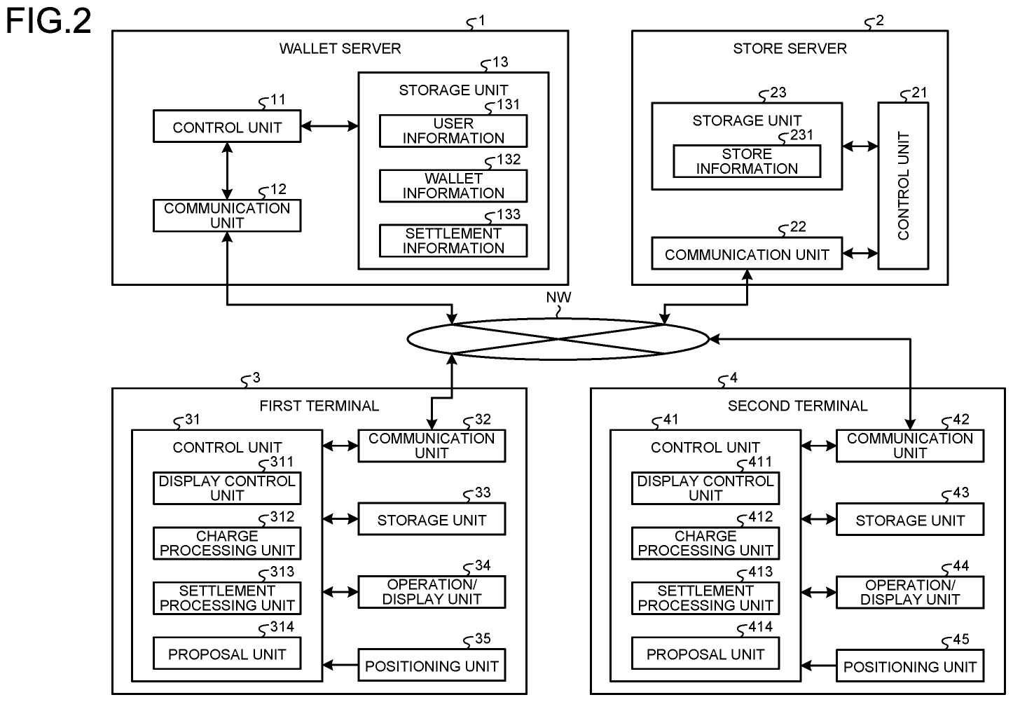

A configuration of the wallet system according to the embodiment will be described with reference to FIGS. 1 and 2. As illustrated in FIG. 1, the wallet system includes a wallet server (first server) 1, a store server (second server) 2, a first terminal 3, and a second terminal 4. In the wallet system, the wallet server 1, the store server 2, the first terminal 3, and the second terminal 4 may communicate with each other through a network NW. The network NW includes, for example, an internet line network and a mobile phone line network. Note that, although only one store server 2 is illustrated in FIG. 1, there may be a plurality of the store servers 2.

The wallet server 1 is a server for managing the wallet system according to the embodiment. This wallet server 1 is implemented by a general-purpose computer such as a workstation or a personal computer. In addition, the wallet server 1 is managed by an administrator (provider) of the wallet system. As illustrated in FIG. 2, the wallet server 1 includes a control unit (first processor) 11, a communication unit 12, and a storage unit 13.

Specifically, the control unit 11 includes a processor including a central processing unit (CPU), a digital signal processor (DSP), and a field-programmable gate array (FPGA), and a memory (main storage unit) including a random access memory (RAM) and a read only memory (ROM). The control unit 11 loads a program stored in the storage unit 13 into a work area of the main storage unit, executes the program, and controls each component and the like through the execution of the program, thereby implementing a function matching a predetermined purpose.

The communication unit 12 includes, for example, a local area network (LAN) interface board and a wireless communication circuit for wireless communication. The communication unit 12 is connected to the network NW such as the Internet serving as a public communication network. In addition, by connecting to the network NW, the communication unit 12 communicates with the store server 2, the first terminal 3, and the second terminal 4.

The storage unit 13 includes a recording medium such as an erasable programmable ROM (EPROM), a hard disk drive (HDD), and a removable medium. Examples of the removable medium include a disc recording medium such as a universal serial bus (USB) memory, a compact disc (CD), a digital versatile disc (DVD), and a Blu-ray (registered trademark) disc (BD). The storage unit 13 may store an operating system (OS), various programs, various tables, various databases, and the like. The storage unit 13 also stores user information 131, wallet information 132, and settlement information 133, for each user of the wallet system.

The user information 131 is information regarding a user who uses the wallet system. Examples of the user information 131 includes a user ID of the user who has registered to use the wallet system in advance, a password, a name of the user, contact information (for example, address, phone number, and email address) of the user, and when the user shops at a store (a member store of the wallet system), a moving route in the store. Note that, in the user information 131, the user ID and the password are used for authentication processing such as login to the wallet server 1.

The wallet information 132 is information regarding an electronic wallet (hereinafter, “wallet”) of the wallet system. The wallet indicates a virtual deposit/withdrawal account of electronic money. Examples of the wallet information 132 include a user ID, a balance of electronic money, a charge history of electronic money, and a use history of electronic money.

The settlement information 133 is information regarding settlement of the wallet system. The settlement information 133 includes a user ID, a settlement method used for settlement (for example, electronic money payment (contactless payment), scan payment, and code payment), and a purchase history of products. In addition, examples of the “purchase history of products” include a name of a store, an address of the store, a name of a purchased product, a price of the purchased product, and a date and time of purchase.

The store server 2 is a server provided in a store which is a member store of the wallet system according to the embodiment. This store server 2 is implemented by a general-purpose computer such as a workstation or a personal computer.

As illustrated in FIG. 2, the store server 2 includes a control unit (second processor) 21, a communication unit 22, and a storage unit 23. The control unit 21, the communication unit 22, and the storage unit 23 are similar to the control unit 11, the communication unit 12, and the storage unit 13. In addition, the storage unit 23 stores store information 231.

The store information 231 is information regarding a store and products handled in the store. The store information 231 includes a name of the store, an address of the store, a display position of each product in the store, a price of each product, and a layout of the store. Note that the “layout of the store” refers to, for example, position information of an entrance, an exit, a passage, a cash register, or the like of the store.

The first terminal 3 is a mobile terminal owned by a first user. The “first user” in the present disclosure refers to a person who uses the wallet system and is requested to shop or the like (requested person) by a second user who owns the second terminal 4. Through the first terminal 3, the first user may deposit electronic money (hereinafter referred to as “charge”) and perform settlement using the electronic money. Examples of the first terminal 3 include a smartphone, a mobile phone, a tablet terminal, and a wearable computer, which are owned by the first user.

As illustrated in FIG. 2, the first terminal 3 includes a control unit (second processor) 31, a communication unit 32, a storage unit 33, an operation/display unit (display) 34, and a positioning unit 35. The control unit 31, the communication unit 32, and the storage unit 33 are similar to the control unit 11, the communication unit 12, and the storage unit 13. The control unit 31 functions as a display control unit 311, a charge processing unit 312, a settlement processing unit 313, and a proposal unit 314 through execution of a program.

The display control unit 311 controls display contents on the operation/display unit 34. Based on operation of the first user (touch operation, flick operation, and the like), the display control unit 311 displays predetermined information on the operation/display unit 34. Examples of the information displayed on the operation/display unit 34 by the display control unit 311 include a member registration screen for the first user to register as a member of the wallet system, a login screen for the first user to log in to the wallet system, and a charge screen for the first user to charge electronic money to the wallet.

The charge processing unit 312 charges (deposits) electronic money to the wallet. Based on operation of the first user, the charge processing unit 312 outputs, to the wallet server 1, a charge request for charging electronic money to the wallet by a charging method registered (associated) in advance. Note that the “charging method” refers to a method for charging electronic money to the wallet serving as a virtual deposit/withdrawal account. Examples of the charging method include a bank account and a credit card. In addition, a plurality of charging methods may be registered, and electronic money may be charged by any of the charging methods.

The control unit 11 of the wallet server 1 that has acquired the charge request from the charge processing unit 312 based on the operation of the first user increases a balance of electronic money in the wallet of the first user based on charge amount information included in the charge request. That is, the control unit 11 updates the wallet information 132 of the first user stored in the storage unit 13 in accordance with the increase in the balance of electronic money in the wallet of the first user. The control unit 11 then outputs information that charging to the wallet is completed (hereinafter referred to as “charge completion information”) to the first terminal 3.

The settlement processing unit 313 outputs, to the store server 2, a settlement request for settlement by using, for example, electronic money charged to the wallet. The store server 2 that has acquired the settlement request from the first terminal 3 outputs the settlement request including a settlement amount to the wallet server 1 via the network NW. The control unit 11 of the wallet server 1 that has acquired the settlement request from the store server 2 reduces a balance of electronic money in the wallet of the first user based on the settlement amount included in the settlement request, and outputs updated wallet information 132 and settlement information 133 to the first terminal 3. In addition, the control unit 11 outputs information that settlement is completed (hereinafter referred to as “settlement completion information”) to the store server 2.

The proposal unit 314 makes various proposals to the first user through the operation/display unit 34. Specifically, the proposal unit 314 acquires position information of the first terminal 3 from the positioning unit 35, and determines whether or not the first user has arrived in the vicinity of a predetermined store based on the position information. Note that the “predetermined store” refers to a member store of the wallet system according to the embodiment. In addition, “the vicinity of the store” refers to a range of several meters in radius around the store, and is appropriately determined in accordance with a distance from the store, at which the first user desires to receive notification.

When determining that the first user has arrived in the vicinity of the store, the proposal unit 314 acquires, from the wallet server 1, a purchase history of products of another user, that is, the second user in the store. Subsequently, the proposal unit 314 displays a product to be purchased by the first user in the store on the operation/display unit 34 based on the acquired purchase history. In this way, by proposing a product to the first user based on the purchase history of the second user, that is, a shopping tendency of the second user, for example, when the first user is requested to shop by the second user, the first user may shop in place of the second user and in accordance with an intention of the second user. Note that, in the following description, when a plurality of users including the first user and the second user are collectively referred to, they are simply referred to as “users”.

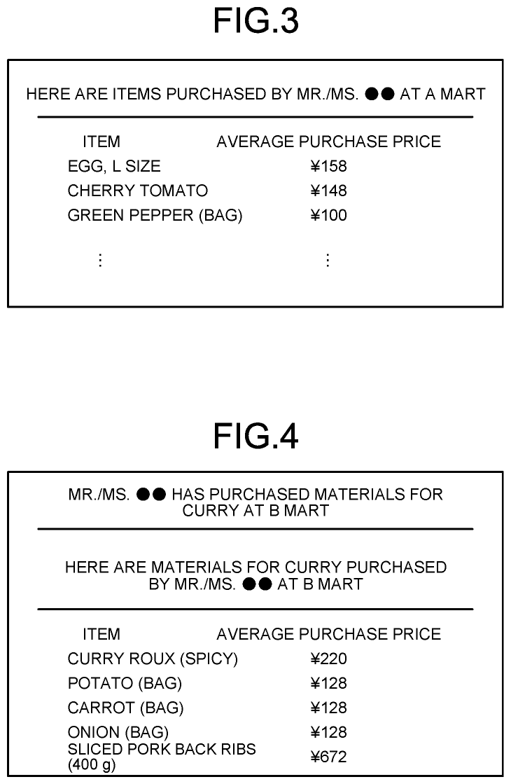

For example, as illustrated in FIG. 3, the proposal unit 314 displays, on the operation/display unit 34, items of products which the second user (Mr./Ms. ●● in FIG. 3) often purchases at the store (A mart in FIG. 3). In addition, as illustrated in FIG. 3, the proposal unit 314 may display, on the operation/display unit 34, average purchase prices of the products along with the items of the products. Note that the “average purchase prices of the products” are calculated in advance based on purchase prices of the products included in the purchase history of the second user. In this way, by displaying the average purchase prices of the products together with the items of the products, the first user may be made to recognize whether a price of a product the first user intends to purchase is higher or lower than the past price (the price when the second user purchased the product).

When the first user arrives in the vicinity of the store, the proposal unit 314 may display items of products selected under a predetermined condition instead of displaying all items of the products which the second user (Mr./Ms. ●●) often purchases at the store (A Mart) as illustrated in FIG. 3. In this case, the proposal unit 314 calculates a purchase cycle of each product by the second user included in the purchase history of the second user. Note that the “purchase cycle of each product” refers to, for example, a cycle (for example, once a week or once a month) in which the second user purchases the same product. In addition, the “purchase cycle of each product” may be rephrased as a “sales cycle of each product” when viewed from the store side. The proposal unit 314 displays a product matching the purchase cycle on the operation/display unit 34.

For example, when the purchase history of the second user includes information that “toilet paper is purchased at the store (A Mart) on a first day of every month”, the proposal unit 314 displays “toilet paper” as an item of a product to the first user visiting the store (A mart) on a first day of a month. In this way, by displaying a product matching the purchase cycle, it is possible to propose to the first user a product (for example, consumables) that the second user often purchases around the same time as the first user visits the store.

In addition, the proposal unit 314 may select a product purchased in a current time zone (for example, morning, daytime, or evening) or a current season (spring, summer, autumn or winter) from among the products included in the purchase history of the second user, and display the selected product on the operation/display unit 34. Thus, a product matching the current time zone or season may be proposed to the first user.

When the first user arrives in the vicinity of the store, the proposal unit 314 may display, on the operation/display unit 34, a moving route (customer flow line) of the first user in the store and a product to be purchased by the first user on the moving route. In this case, the proposal unit 314 acquires, from the wallet server 1, a moving route in the store when the second user has shopped at the store. Note that a moving route of the second user in each store is stored as the user information 131 in the storage unit 13.

Subsequently, the proposal unit 314 acquires information regarding a display position of each product in the store and a layout of the store from the store server 2. Note that the information regarding the display position of each product in the store and the layout of the store is stored as the store information 231 in the storage unit 23. Subsequently, based on the purchase history and the moving route of the second user and the display position of each product, the proposal unit 314 displays, on the operation/display unit 34, a moving route of the first user in the store and a product to be purchased by the first user on the moving route. In this way, by displaying a moving route in the store and a product to be purchased on the moving route, for example, when the first user is requested to shop by the second user, the first user may shop in place of the second user and in accordance with an intention of the second user.

The proposal unit 314 may confirm whether or not the first user who is shopping at the store has forgotten to purchase. In this case, the proposal unit 314 acquires the position information of the first terminal 3 from the positioning unit 35, and acquires the information regarding the layout of the store from the store server 2. Subsequently, the proposal unit 314 determines whether or not the first user has arrived in the vicinity of a cash register of the store based on the position information of the first terminal 3 and the layout of the store.

When determining that the first user has arrived in the vicinity of a cash register of the store, the proposal unit 314 displays the product to be purchased by the first user in the store (see FIG. 3) again on the operation/display unit 34. In this way, when the first user arrives at a cash register of the store, the product to be purchased is displayed again, so that it is possible to prevent the first user from forgetting to purchase the product.

The proposal unit 314 may propose use of a specific store in accordance with a menu of dishes determined by the first user. In this case, the proposal unit 314 acquires information regarding the menu based on operation of the operation/display unit 34 by the first user. Subsequently, the proposal unit 314 selects, based on the purchase history of the second user, a store where the second user has purchased materials for the menu. Note that, when there is a plurality of stores where the second user has purchased materials for the menu, priorities are set based on the number of purchases, prices, and the like, and one store is selected. Subsequently, the proposal unit 314 displays information regarding the selected store and the materials for the menu on the operation/display unit 34.

For example, when the first user inputs “curry” as the menu, as illustrated in FIG. 4, the proposal unit 314 displays, on the operation/display unit 34, a name of a store (B mart) where the second user has purchased materials for a curry in the past and the purchased materials for a curry. In this way, by determining a store to shop based on a menu of dishes, the first user may be guided to a store where materials for the menu are often purchased. Thus, the materials for the menu may be purchased with quality and prices similar to those in the past.

The storage unit 33 stores data of various screens displayed by the display control unit 311 on the operation/display unit 34. The storage unit 33 also stores the position information of the first terminal 3 detected by the positioning unit 35, the user information 131, the wallet information 132, the settlement information 133, and the like as needed.

The operation/display unit 34 includes a touch panel display, for example, and has an input function for accepting operation by a finger of the first user, a pen, or the like, and a display function for displaying various types of information under control of the display control unit 311.

The positioning unit 35 receives radio waves from a global positioning system (GPS) satellite and detects the position information of the first terminal 3. Then, the control unit 31 stores, in the storage unit 33, the position information of the first terminal 3 detected by the positioning unit 35.

The second terminal 4 is a mobile terminal owned by the second user. The “second user” in the present disclosure refers to a person who uses the wallet system and requests the first user who owns the first terminal 3 to shop or the like (requester). Through the second terminal 4, the second user may charge electronic money and perform settlement using the electronic money. Examples of the second terminal 4 include a smartphone, a mobile phone, a tablet terminal, and a wearable computer, which are owned by the second user.

As illustrated in FIG. 2, the second terminal 4 includes a control unit 41, a communication unit 42, a storage unit 43, an operation/display unit 44, and a positioning unit 45. The control unit 41, the communication unit 42, the storage unit 43, the operation/display unit 44, and the positioning unit 45 are similar to the control unit 11, the communication unit 12, the storage unit 13, the operation/display unit 34, and the positioning unit 35. The control unit 41 functions as a display control unit 411, a charge processing unit 412, and a settlement processing unit 413 through execution of a program. Note that functions of the display control unit 411, the charge processing unit 412, the settlement processing unit 413, and a proposal unit 414 are similar to those of the display control unit 311, the charge processing unit 312, the settlement processing unit 313, and the proposal unit 314, and therefore descriptions thereof will be omitted.

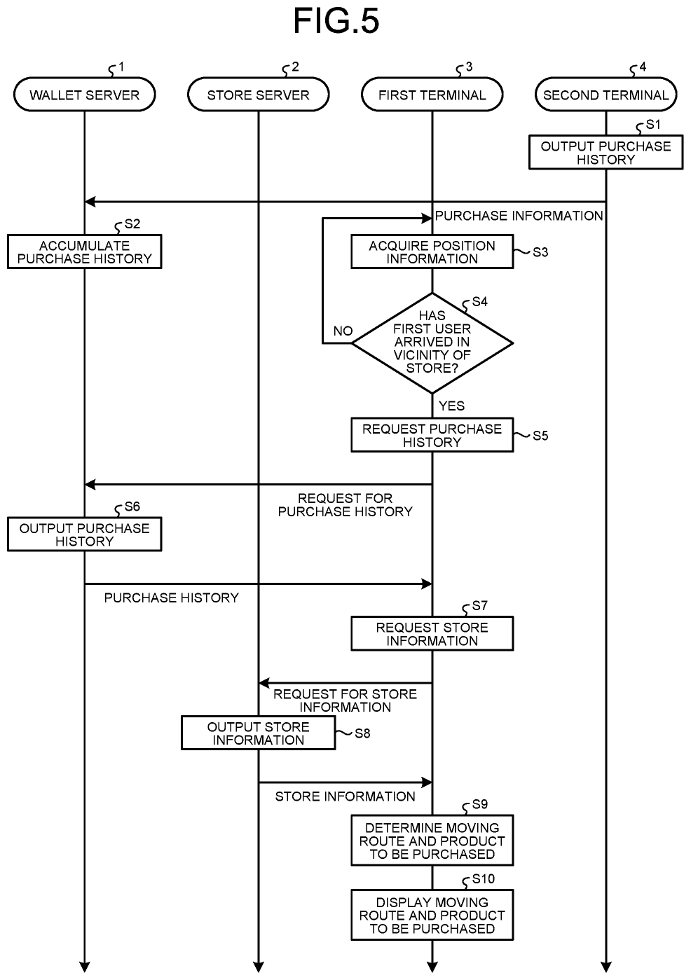

Hereinafter, an example of a method of proposing a product executed by the wallet system according to the embodiment will be described with reference to FIG. 5. Here, a description will be given of a case where, when the first user arrives in the vicinity of a store, a moving route (customer flow line) of the first user in the store and a product to be purchased by the first user on the moving route are proposed.

First, the control unit 41 of the second terminal 4 outputs a purchase history of products to the wallet server 1 each time shopping is done at a store (Step S1). In response to this, the control unit 11 of the wallet server 1 accumulates, in the storage unit 13, the purchase history of the second user as the user information 131 (Step S2).

Subsequently, the proposal unit 314 of the first terminal 3 acquires position information of the first terminal 3 detected by the positioning unit 35 (Step S3), and determines, based on the position information, whether or not the first user has arrived in the vicinity of the store (Step S4).

When determining that the first user has not arrived in the vicinity of the store (No in Step S4), the proposal unit 314 returns to Step S3. On the other hand, when determining that the first user has arrived in the vicinity of the store (Yes in Step S4), the proposal unit 314 requests the wallet server 1 for the purchase history of the second user in the store (Step S5). In response to this, the control unit 11 outputs the purchase history of the second user to the first terminal 3 (Step S6).

Subsequently, the proposal unit 314 requests the store server 2 for the store information (specifically, a display position of each product and a layout of the store) 231 of the store (Step S7). In response to this, the control unit 21 of the store server 2 outputs the store information 231 of the store to the first terminal 3 (Step S8).

Subsequently, based on the purchase history and the moving route of the second user and the display position of each product, the proposal unit 314 determines a moving route of the first user in the store and a product to be purchased by the first user on the moving route (Step S9), and displays the moving route of the first user and the product to be purchased by the first user on the operation/display unit 34 (Step S10).

As described above, according to the wallet program, the wallet system, and the method of proposing a product according to the embodiment, by proposing a product to the first user based on a purchase history of the second user, the first user may shop in place of the second user. Thus, the first user and the second user may make or accept a shopping request without stress. Therefore, convenience of the wallet system may be improved.

For example, in the wallet program, the wallet system, and the method of proposing a product according to the embodiment, an example has been described in which a product is proposed to the first user who owns the first terminal 3 based on a purchase history of the second user who owns the second terminal 4. However, the product may be proposed to the second user based on a purchase history of the first user. In this case, the proposal unit 414 of the second terminal 4 performs processing similar to that of the proposal unit 314 of the first terminal 3 to make various proposals to the second user.

According to the present disclosure, convenience of a wallet system may be improved.

Although the disclosure has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A non-transitory computer-readable recording medium on which an executable program is recorded, the program causing a processor of a computer to execute:
acquiring, when it is detected that a first user has arrived in a vicinity of a predetermined store, a purchase history of products of a second user in the store from a first server; and
displaying, based on the purchase history, a product to be purchased by the first user in the store on a display provided in a mobile terminal.

2. The non-transitory computer-readable recording medium according to claim 1, wherein the program causes the processor to execute:
calculating a purchase cycle of each product by the second user, the purchase cycle being included in the purchase history; and
displaying a product matching the purchase cycle on the display.

3. The non-transitory computer-readable recording medium according to claim 1, wherein the program causes the processor to execute:
selecting a product purchased in a current time zone or a current season from among products included in the purchase history; and
displaying the selected product on the display.

4. The non-transitory computer-readable recording medium according to claim 1, wherein the program causes the processor to execute:
acquiring, from the first server, a moving route of the second user in the store when the second user has shopped at the store;
acquiring, from a second server, information including a display position of each product in the store; and
displaying, based on the purchase history, the moving route, and the display position, a moving route of the first user in the store and a product to be purchased by the first user on the moving route on the display.

5. The non-transitory computer-readable recording medium according to claim 1, wherein the program causes the processor to execute:
calculating an average purchase price of each product included in the purchase history; and
displaying the average purchase price together with the product to be purchased by the first user on the display.

6. The non-transitory computer-readable recording medium according to claim 1, wherein the program causes the processor to execute:
displaying again the product to be purchased by the user in the store on the display, when it is detected that the first user has arrived in a vicinity of a cash register of the store.

7. The non-transitory computer-readable recording medium according to claim 1, wherein the program causes the processor to execute:
acquiring information regarding a menu of dishes determined by the first user;
selecting, based on the purchase history, a store where the second user has purchased materials for the menu; and
displaying information regarding the selected store on the display.

8. A wallet system comprising:
a first server comprising a first processor comprising hardware; and
a mobile terminal comprising
a display, and
a second processor comprising hardware, the second processor being configured to
acquire, when it is detected that a first user has arrived in a vicinity of a predetermined store, a purchase history of products of a second user in the store from a first server, and
display, based on the purchase history, a product to be purchased by the first user in the store on the display.

9. The wallet system according to claim 8, wherein the second processor is configured to:
calculate a purchase cycle of each product by the second user, the purchase cycle being included in the purchase history; and
display a product matching the purchase cycle on the display.

10. The wallet system according to claim 8, wherein the second processor is configured to:
select a product purchased in a current time zone or a current season from among products included in the purchase history; and
display the selected product on the display.

11. The wallet system according to claim 8, comprising a second server comprising a third processor comprising hardware, wherein
the second processor is configured to
acquire, from the first server, a moving route of the second user in the store when the second user has shopped at the store,
acquire, from the second server, information including a display position of each product in the store, and
display, based on the purchase history, the moving route, and the display position, a moving route of the first user in the store and a product to be purchased by the first user on the moving route on the display.

12. The wallet system according to claim 8, wherein the second processor is configured to:
calculate an average purchase price of each product included in the purchase history; and
display the average purchase price together with the product to be purchased by the first user on the display.

13. The wallet system according to claim 8, wherein the second processor is configured to display again the product to be purchased by the first user in the store on the display, when it is detected that the first user has arrived in a vicinity of a cash register of the store.

14. The wallet system according to claim 8, wherein the second processor is configured to:
acquire information regarding a menu of dishes determined by the first user;
select, based on the purchase history, a store where the second user has purchased materials for the menu; and
display information regarding the selected store on the display.

15. A method of proposing a product, the method comprising:
acquiring, when it is detected that a first user has arrived in a vicinity of a predetermined store, a purchase history of products of a second user in the store from a first server; and
displaying, based on the purchase history, a product to be purchased by the first user in the store on a display provided in a mobile terminal.

16. The method according to claim 15, further comprising:
calculating a purchase cycle of each product, the purchase cycle being included in the purchase history; and
displaying a product matching the purchase cycle on the display.

17. The method according to claim 15, further comprising:
selecting a product purchased in a current time zone or a current season from among products included in the purchase history; and
displaying the selected product on the display.

18. The method according to claim 15, further comprising:
acquiring, from the first server, a moving route of the second user in the store when the second user has shopped at the store;
acquiring, from a second server, information including a display position of each product in the store; and
displaying, based on the purchase history, the moving route, and the display position, a moving route of the first user in the store and a product to be purchased by the first user on the moving route on the display.

19. The method according to claim 15, further comprising:
calculating an average purchase price of each product included in the purchase history; and
displaying the average purchase price together with the product to be purchased by the first user on the display.

20. The method according to claim 15, further comprising
displaying again the product to be purchased by the first user in the store on the display, when it is detected that the first user has arrived in a vicinity of a cash register of the store.
